(19) United States
(12) Patent Application Publication
(10) Pub. No.: US 2012/0210918 A1
(43) Pub. Date: Aug. 23, 2012

(54) High Clearance Crop Inter-Seeding

(75) Inventors: David Pell, Jackson, MN (US); John Peterson, Jackson, MN (US)

(73) Assignee: AGCO Corporation, Duluth, GA (US)

(21) Appl. No.: 13/330,869

(22) Filed: Dec. 20, 2011

Related U.S. Application Data
(60) Provisional application No. 61/428,252, filed on Dec. 30, 2010.

(51) Int. Cl. A01C 7/18; A01C 5/06

(52) U.S. Cl. 111/57; 111/53

(57) ABSTRACT

An inter-seeding unit may be provided. The inter-seeding unit may comprise an upper suspension unit and an intermediate joint connected to the upper suspension unit. The inter-seeding unit may further comprise a row unit connected to the intermediate joint. The row unit may comprise a seeding device.

### RELATED APPLICATION

Under provisions of 35 U.S.C. §119(e), Applicants claim the benefit of U.S. provisional application No. 61/428,252, filed Dec. 30, 2010, which is incorporated herein by reference.

### BACKGROUND

A tractor is a vehicle designed to deliver a high torque at slow speeds for hauling a trailer or machinery used in agriculture or construction. “Tractor” is most commonly used to describe a farm vehicle. Agricultural implements may be towed behind or mounted on the tractor, and the tractor may also provide a source of power if the implement is mechanized.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A high clearance crop inter-seeding system may be provided. The high clearance crop inter-seeding system may comprise an inter-seeding unit. The inter-seeding unit may comprise an upper suspension unit and an intermediate joint connected to the upper suspension unit. The inter-seeding unit may further comprise a row unit connected to the intermediate joint. The row unit may comprise a seeding device.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 shows a high crop clearance inter-seeding system;

FIG. 2 shows a high crop clearance inter-seeding system;

FIG. 3 shows an inter-seeding unit; and

FIGS. 4A and 4B show a seeding device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Consistent with embodiments of the invention, a high clearance crop inter-seeding system may be provided. This system may allow a secondary crop to be inter-seeded into a standing primary crop. Inter-seeding units may be mounted to a self propelled vehicle or pull-behind vehicle that may provide a delivery system (e.g. for metering of seed or fertilizer) and propulsion of the inter-seeding units. The inter-seeding units may comprise multiple rolling, seeding devices and may attach to a folding mechanical “boom arm” at the rear of the vehicle. The inter-seeding units may be spaced along the boom arm to place seed and/or fertilizer in between existing rows of growing, standing, primary crops and may provide enough clearance to not damage the growing, standing, primary crops. Embodiments of the invention may be used to plant a secondary crop in an already standing primary crop with the intention to harvest the secondary crop. Furthermore, embodiments of the invention may be used to plant a cover crop in an already standing primary crop before harvest of the primary crop to limit soil erosion during harvest of the primary crop.

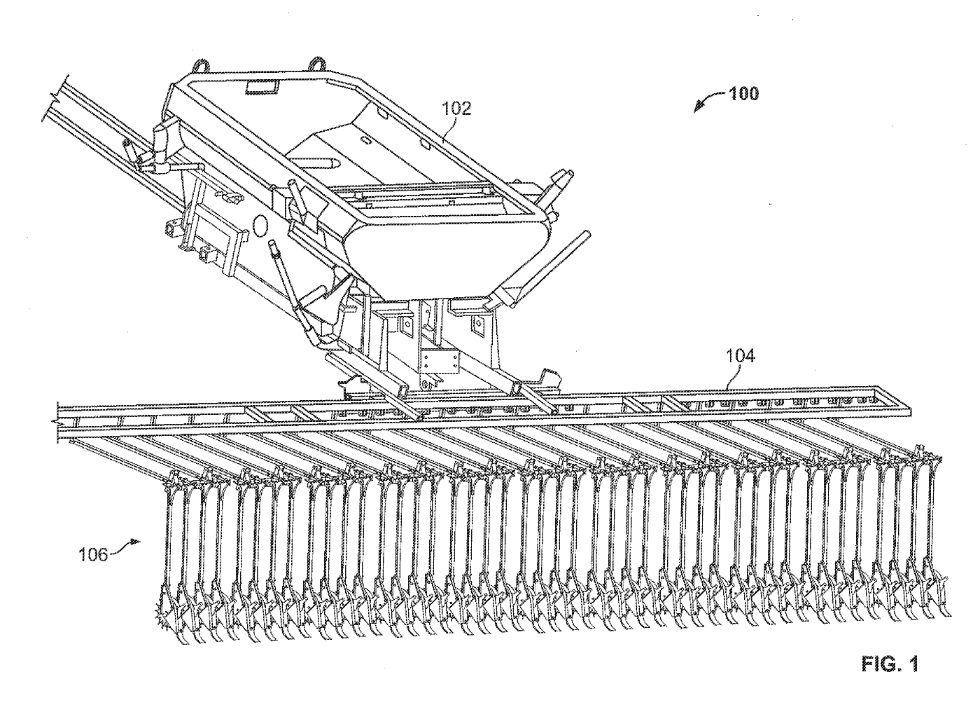

FIG. 1 shows a high crop clearance inter-seeding system 100. As shown in FIG. 1, system 100 may include a delivery system 102, a boom arm 104, and a plurality of inter-seeding units 106. Delivery system 102 may be mounted on a self propelled agricultural vehicle or may be mounted to a vehicle that may be pulled by an agricultural vehicle (e.g. a tractor.) Delivery system 102 may comprise and air delivery system that my provide metering of seeds and/or fertilizer to the plurality of inter-seeding units 106 through tubes, for example. Plurality of inter-seeding units 106 may be mounted to boom arm 104 that may also be mounted on the self propelled agricultural vehicle or may be mounted to the vehicle that may be pulled by the agricultural vehicle.

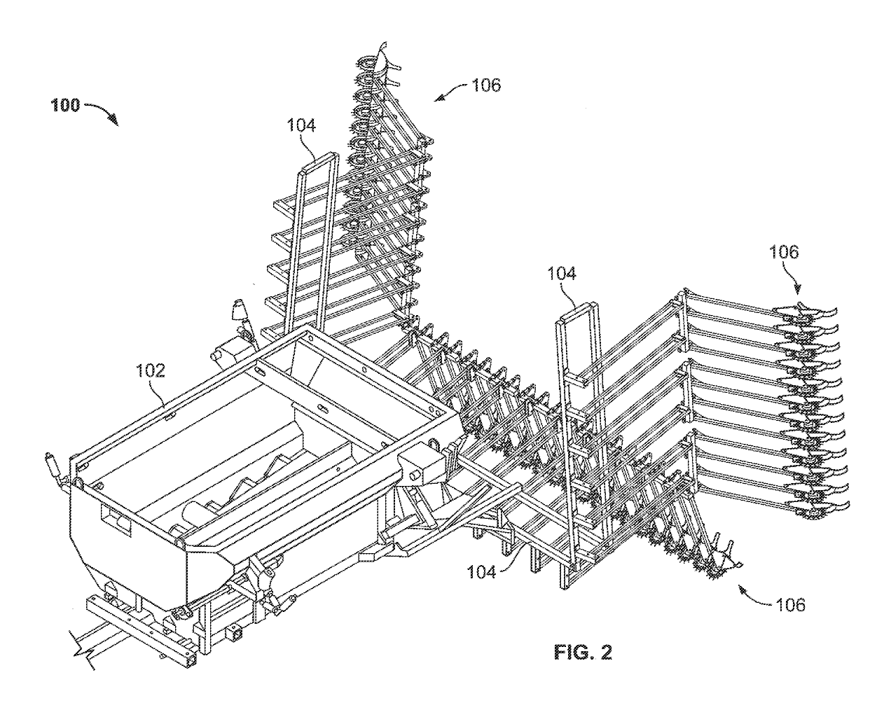

System 100 may allow a secondary crop (or a cover crop) to be inter-seeded into a standing primary crop. Inter-seeding units 106 may be spaced along boom arm 104 to place seed and/or fertilizer in between existing rows of a growing, standing primary crop and may provide enough clearance to not damage the growing, standing primary crop. For example, the growing, standing primary crop may pass unharmed through inter-seeding units 106 as system 100 is propelled through an agricultural field containing the growing primary crop. FIG. 2 shows high crop clearance inter-seeding system 100 where boom arm 104 is folded for transportation, for example.

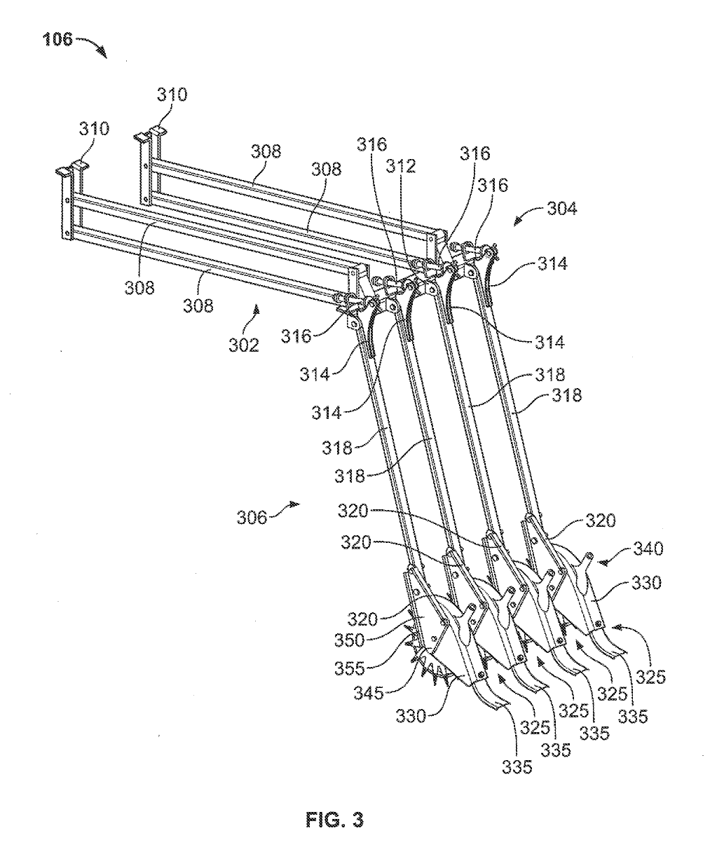

FIG. 3 shows inter-seeding unit 106. As shown in FIG. 3, inter-seeding unit 106 may comprise an upper suspension unit 302, an intermediate joint 304, and a row unit 306. Upper suspension unit 302 may comprise a plurality of upper suspension arms 308 and a plurality of brackets 310. Brackets 310 may be attached to boom arm 104 and may be configured to allow inter-seeding unit 106 to adjust up or down on boom arm 104 based, for example, on the height of the standing, existing primary crop. Upper suspension arms 308 may protrude horizontally from boom arm 104 and may be substantially parallel to the ground.

Intermediate joint 304 may comprise a joint bar 312, a plurality of hinges 314, and a plurality of tension springs 316. Joint bar 312 may be attached to plurality of upper suspension arms 308. Plurality of hinges 314 may be attached to joint bar 312 and to a plurality of corresponding lower suspension arms 318 of row unit 306 as will be described below. Each one of plurality of lower suspension arms 318 may be configured to hinge from corresponding ones of plurality of hinges 314. Plurality of tension springs 316 may be disposed on corresponding ones of plurality of hinges 314 in such a way as to place a downward force on lower suspension arms 318 against the ground, for example, when inter-seeding unit 106 is in operation. In other words, plurality of tension springs 316 may provide tension that causes row unit 306 (and specifically seeding devices 325) to follow the contour of the ground.

Row unit 306 may comprise lower suspension arms 318, brackets 320, and seeding devices 325. Lower suspension arms 318 may be spaced along boom arm 104 to, for example, allow the growing, standing primary crop to pass unharmed between lower suspension arms 318 as system 100 is propelled through the agricultural field containing the growing primary crop. Moreover, upper suspension unit 302 may be adjusted up or down on brackets 310 to allow joint bar 312 to pass the growing, standing primary crop through with out harm to the growing, standing primary crop.

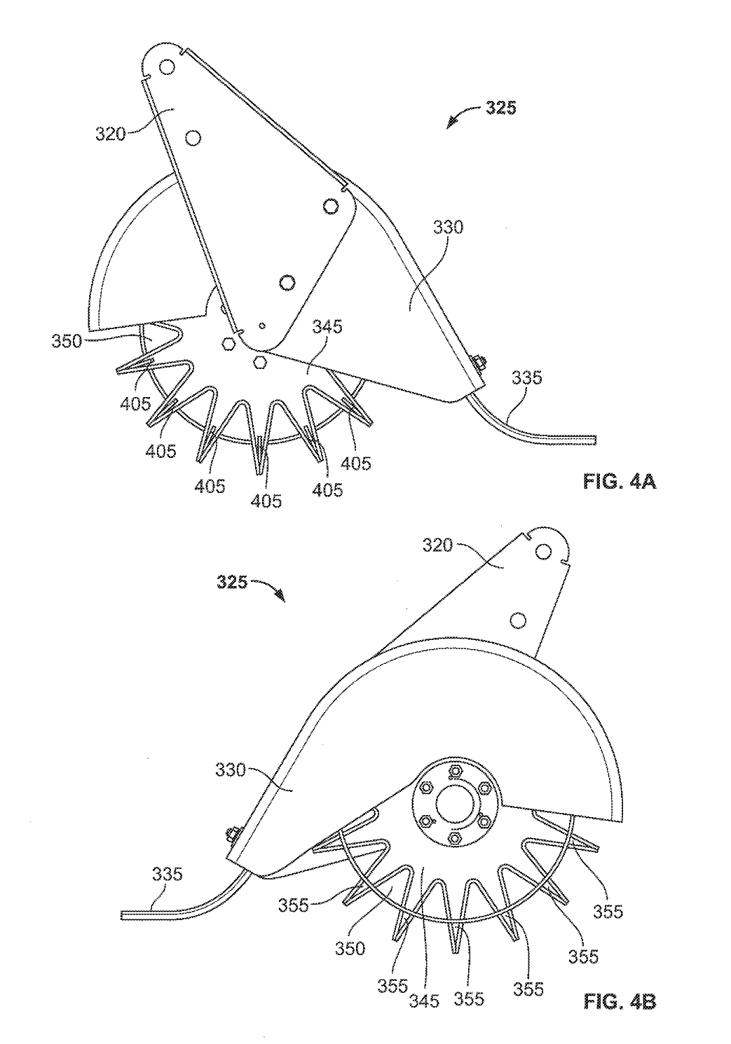

Each seeding device 325 may comprise a hood 330, a pad 335, an orifice 340, and an opener 345. Each opener 345 may comprise a depth control ring 350 and a plurality of points 355. Opener 345 may be configured to rotate inside hood 330. Pad 335 may be connected to an end of hood 330. FIG. 4A and FIG. 4B show seeding device 325 in more detail. As shown in FIG. 4A, plurality of points 355 may each include a corresponding tab 405 to aid in soil mixing, for example, inside hood 330. Brackets 320 may each connect corresponding seeding devices 325 to corresponding lower suspension arms 318. Tubes (not shown) from delivery system 102 may connect delivery system 102 to each seeding device 325 at orifice 340. The tubes may deliver seeds and/or fertilizer from delivery system 102 to an interior of hood 330 through orifice 340.

Consistent with embodiments of the invention, during operation of inter-seeding unit 106, pads 335 and depth control ring 350 may follow the contour of the ground as high crop clearance inter-seeding system 100 is propelled forward in a field with an existing, standing primary crop. While rotating inside hood 330, opener 345 of each seeding device 325 may disturb the soil from the ground, mix the disturbed soil with a seed and/or fertilizer from delivery system 102, place the seed and/or fertilizer in the ground, and firm the soil against the seed by pad 335 to insure adequate contact to promote germination. Hood 330 may provide at least two functions. One function of hood 330 may be to protect the existing primary crop from damage by opener 345, for example. Another function of hood 330 may be to provide a place for the disturbed soil and the seed and/or fertilizer delivery system 102 to be mixed thoroughly before being placed in the ground and firmed by pad 335. This mixing may be facilitated or enhanced by tabs 405.

While certain embodiments of the invention have been described, other embodiments may exist. Further, any disclosed methods' stages may be modified in any manner, including by reordering stages and/or inserting or deleting stages, without departing from the invention. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. An inter-seeding unit comprising:
an upper suspension unit;
an intermediate joint connected to the upper suspension unit; and
a row unit connected to the intermediate joint.

2. The inter-seeding unit of claim 1, wherein the upper suspension unit comprises a plurality of upper suspension arms.

3. The inter-seeding unit of claim 2, wherein the upper suspension unit comprising at least one bracket configured to connect at least one of the plurality of upper suspension arms to a boom arm.

4. The inter-seeding unit of claim 3, wherein the at least one bracket is configured to adjust up and down vertically on the boom arm.

5. The inter-seeding unit of claim 3, wherein the boom arm is connected to an agricultural vehicle.

6. The inter-seeding unit of claim 2, wherein the plurality of upper suspension arms are substantially parallel to the ground.

7. The inter-seeding unit of claim 1, wherein the intermediate joint comprises a joint bar.

8. The inter-seeding unit of claim 7, wherein the joint bar connects to a plurality of upper suspension arms of the upper suspension unit.

9. The inter-seeding unit of claim 7, wherein the intermediate joint comprises a plurality of hinges connected to the joint bar.

10. The inter-seeding unit of claim 9, wherein the intermediate joint comprises a plurality tension springs correspondingly connected to the plurality of hinges.

11. The inter-seeding unit of claim 1, wherein the row unit comprises:
at least one lower suspension arm;
a bracket connected to the at least one lower suspension arm; and
a seeding device connected to the bracket.

12. The inter-seeding unit of claim 11, wherein the seeding device comprises a hood.

13. The inter-seeding unit of claim 12, wherein the seeding device comprises a pad connected to the hood.

14. The inter-seeding unit of claim 12, wherein the seeding device comprises an orifice disposed on the hood.

15. The inter-seeding unit of claim 11, wherein the seeding device comprises an opener.

16. The inter-seeding unit of claim 15, wherein the opener comprises a plurality points.

17. The inter-seeding unit of claim 16, wherein each of the plurality of points comprises a tab.

18. The inter-seeding unit of claim 15, wherein the opener comprises a depth control ring.

19. An inter-seeding unit comprising:
an upper suspension unit wherein the upper suspension unit comprises a plurality of upper suspension arms being substantially parallel to the ground wherein the upper suspension unit comprises at least one bracket configured to connect at least one of the plurality of upper suspension arms to a boom arm connected to an agricultural vehicle wherein the at least one bracket is configured to adjust up and down vertically on the boom arm;
an intermediate joint connected to the upper suspension unit, wherein the intermediate joint comprises,
a joint bar wherein the joint bar connects to the plurality of upper suspension arms,
a plurality of hinges connected to the joint bar, and
a plurality tension springs correspondingly connected to the plurality of hinges; and
a row unit connected to the plurality of hinges.

20. An inter-seeding unit comprising:
an intermediate joint; and
a row unit connected to the intermediate joint wherein the row unit comprises,
at least one lower suspension arm,
a bracket connected to the at least one lower suspension arm, and
a seeding device connected to the bracket wherein the seeding device comprises,
a hood, wherein a pad is connected to the hood and an orifice is disposed on the hood,
an opener comprising a plurality points wherein each of the plurality of points comprises a corresponding tab wherein an interior of the hood is configured to provide an area where soil and at least one seed received through the orifice are mixed by the tabs, and
a depth control ring.
